(19) United States
(12) Patent Application Publication
(10) Pub. No.: US 2008/0103846 A1
(43) Pub. Date: May 1, 2008

(54) Sales funnel management method and system

(76) Inventors: Albert Bacon Armstrong, Peoria, IL (US); Terry Joe Vance, Dunlap, IL (US); Robert Emmett Gorman, Leahwood, KS (US); Theodore A. Gambogi, Singapore (SG); Rodney Alan Topel, Peoria, IL (US); James Arthur Simmons, Morton, IL (US); John Paul Janes, Raleigh, NC (US)

Correspondence Address: CATERPILLAR/FINNEGAN, HENDERSON, L.L.P., 901 New York Avenue, NW, WASHINGTON, DC, 20001-4413, US

(21) Appl. No.: 11/589,969

(22) Filed: Oct. 31, 2006

(51) Int. Cl. G06F 9/44

(52) U.S. Cl. 705/7

(57) ABSTRACT

A method for developing a business plan for a business entity includes providing a value indicating a predicted amount of business entity sales for one or more products. The method further includes, based on the provided value, determining, for each of one or more sales sources, an expected amount of opportunities necessary to generate the predicted amount of business entity sales. The method additionally includes storing a respective indicator of the predicted amount of opportunities for each of the one or more sales sources, and using the one or more respective indicators to develop a business plan.

### TECHNICAL FILED

The present disclosure relates generally to sales funnel management, and more particularly to a method and system for providing sales funnel management to achieve a business plan.

### BACKGROUND

A “sales funnel” is a model used to visualize the progress of sales opportunities as they progress from an initial opportunity stage through a final sale phase. The term “funnel” is used because most often, the number of opportunities entering the model is larger than the number of completed sales. Typically, a sales department of a company monitors the number of opportunities entering the funnel, the number of completed sales, and the number of opportunities passing through various stages of the funnel. The company may then use the collected data to analyze the effectiveness of its sales department.

For example, U.S. Patent Application Publication No. 2002/0077998 (“the '998 publication”), to Andrews et al., describes a system for managing leads and sales. The system tracks leads as they pass through various stages of a sales funnel, and provides a user with options to view different reports, such as a sales funnel report, sales forecast, won and lost deals, contact information, etc. A user may then view these reports.

While the '998 publication describes a system that may be used to help a company manage sales deals, the system has a number of shortcomings. For example, the '998 publication does not describe a simple way to compare a desired business plan to actual sales and leads moving through the sales funnel. Thus, users cannot easily assess whether present sales are in line with a desired business plan. Furthermore, the '998 publication does not address how to determine the number of leads necessary to achieve a desired number of sales. The '998 publication further fails to differentiate sales generated from a marketing department from sales generated from a sales department. Because of these shortcomings, the '998 publication fails to describe an efficient way to both develop a business plan and to execute the business plan.

The disclosed embodiments are directed to overcoming one or more of the problems set forth above.

### SUMMARY OF THE INVENTION

A first embodiment includes a method for developing a business plan for a business entity. The method includes providing a value indicating a predicted amount of business entity sales for one or more products. The method further includes, based on the provided value, determining, for each of one or more sales sources, an expected amount of opportunities necessary to generate the predicted amount of business entity sales. The method additionally includes storing a respective indicator of the predicted amount of opportunities for each of the one or more sales sources, and using the one or more respective indicators to develop a business plan.

A second embodiment includes a method for determining an amount of opportunities for a business entity to generate. The method includes providing at least one expected industry sales value to a data file, the at least one expected industry sales value indicating an expected amount of sales over a period of time for one or more products. The method further includes calculating an estimated amount of opportunities that must be generated by each of a plurality of sales sources to result in the expected amount of sales, thereby calculating a first set of opportunity values. The method additionally includes displaying the first set of opportunity values, and providing at least one desired business entity sales value to the data file, the at least one desired business entity sales value indicating a desired amount of sales to make over a period of time for the one or more products by the business entity. In addition, the method includes calculating a second set of opportunity values reflecting opportunities that must be generated by each of the plurality of sales sources to result in the desired amount of sales, and displaying the second set of opportunity values. The method further includes using the second set of opportunity values to develop a business plan for the business entity.

A third embodiment includes a computer program product stored on a computer-readable medium. The computer program product includes instructions that, when executed, instruct one or more processors to store a value indicating a predicted amount of business entity sales for one or more products. The computer program product further includes instructions that, when executed, determine, for each of one or more sales sources, an expected amount of opportunities necessary to generate the predicted amount of business entity sales, based on the stored value. The computer program product additionally includes instructions that, when executed, instruct the one or more processors to store an indicator of the predicted amount of opportunities for each of the one or more sales sources, and instructions that, when executed, instruct the one or more processors to display the stored one or more indicators.

### BRIEF DESCRIPTION OF THE DRAWINGS

FIG. 1 is a block diagram of an exemplary business system consistent with certain disclosed embodiments;

FIG. 2 is a model of an exemplary sales funnel consistent with certain disclosed embodiments;

FIGS. 3a, 3b, and 3c are diagrams of an exemplary business plan data file consistent with certain disclosed embodiments;

FIGS. 4a and 4b are diagrams of an exemplary sales monitoring data file consistent with certain disclosed embodiments;

FIG. 5 is a flow chart illustrating an exemplary method consistent with certain disclosed embodiments;

### DETAILED DESCRIPTION

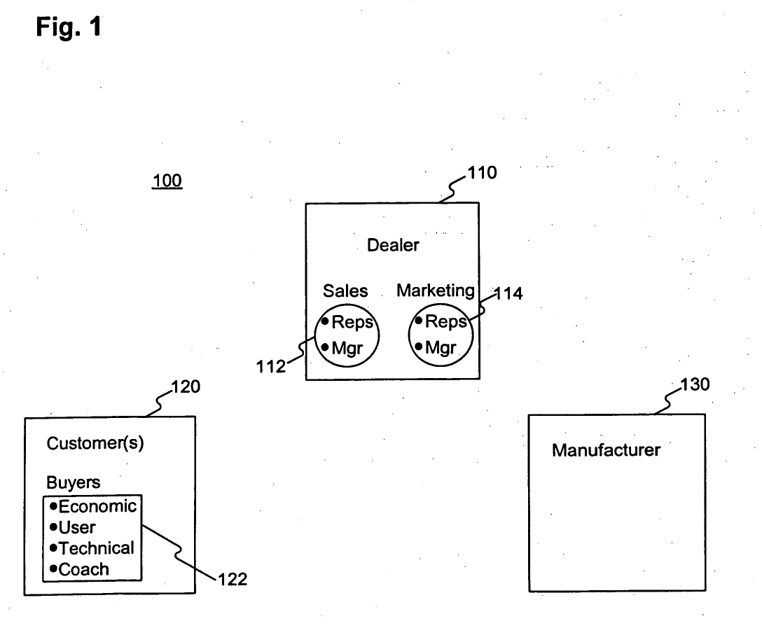

FIG. 1 depicts an exemplary business system 100 consistent with certain disclosed embodiments. In one embodiment, system 100 includes a dealer 110, one or more customers 120, and a manufacturer 130. Dealer 110 may be any company, non-profit organization, corp oration, educational institution, individual, or other entity that purchases products and/or services from one or more manufacturers, such as manufacturer 130, and sells the products and/or services to one or more customers, such as customers 120. Customers 120 may be any company, non-profit organization, corporation, educational institution, individual, or other entity that purchases products and/or services from one or more dealers, such as dealer 110. Manufacturer 130 may be any company, non-profit organization, corporation, educational institution, individual, or other entity that manufactures products and sells products and/or services to one or more entities, such as dealer 120. The term “entity,” as used herein, refers to any individual, group, company, corporation, educational institution, governmental agency, non-profit organization, or other party or group of parties capable of purchasing and/or selling products and/or services. The term “product,” or “products” as used herein, refers to one or more products and/or services.

In one embodiment, dealer 110 includes a sales department 112 and a marketing department 114. Sales department 112 may include one or more sales representatives who contact potential customers and may sell products to those customers, and one or more sales managers who manage the sales representatives. Marketing department 114 may include one or more marketing representatives who also contact potential customers and pass on those potential customers to sales representatives, and one or more marketing managers who manage the marketing representatives. Dealer 110 may also include additional departments (not shown).

Customers 120 may include one or more entities that purchase products from one or more dealers, such as dealer 110. In one embodiment, a customer 120 is a company that includes different types of “buyers” 122. For example, one type of buyer may be an “economic buyer,” who gives final approval for any purchases and authorizes spending by the company. Another type of buyer may be a “user buyer,” who assesses benefits of purchased products and their impact on job performance. A third type of buyer may be a “technical buyer,” who assesses the price of a product and compares it to other available products. In one embodiment, a “technical buyer” may refuse a purchase, but cannot complete a purchase without approval. A fourth type of buyer may be a “coach,” who can make recommendation for sales, but who still needs approval to complete a purchase. As such, in one embodiment, all purchases by a customer 120 must be approved by an “economic buyer.”

Manufacturer 130 may include any entity that manufactures products and sells them to one or more dealers, such as dealer 120. In one embodiment, a manufacturer is a company that makes machines and machine equipment, such as construction machines and equipment, vehicles and vehicle parts, mining machines and equipment, and other types of machines and equipment. In one embodiment, manufacturer 130 then sells machines and/or equipment and optionally additionally sells services, to one or more dealers, such as dealer 110.

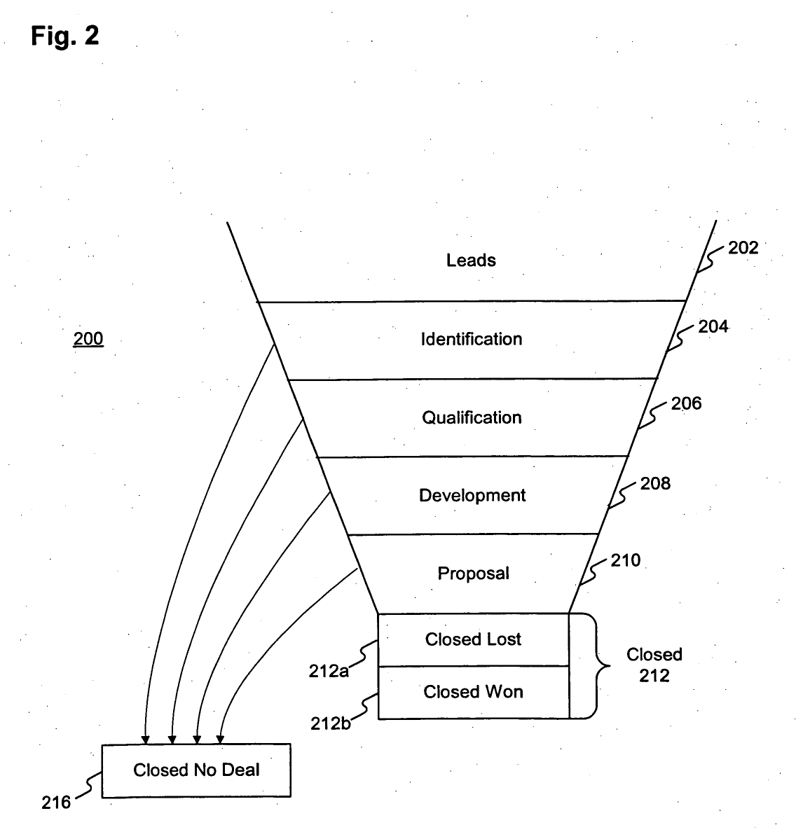

FIG. 2 depicts an exemplary sales funnel 200 consistent with certain disclosed embodiments. Sales funnel 200 is a model depicting various stages in the sales process. The stages may relate to sales of any individual product, or any group of products, provided by an entity, such as dealer 110. In one embodiment, the stages include leads stage 202, identification stage 204, qualification stage 206, development stage 208, proposal stage 210, closed stage 212 (including closed lost stage 212a and closed won stage 212b), and closed no deal stage 216. In one embodiment, both sales department 112 and a marketing department 114 of dealer 110 participate in the sales process.

At lead stage 202, sales leads (hereinafter referred to as “leads”) are identified and may be contacted. These leads may be identified and/or contacted by one or more sources. In one embodiment, some of the leads are identified and/or contacted by members of sales department 112 and others are identified and/or contacted by members of marketing department 114. Leads may include any potential purchaser, such as entities contacted at trade shows, via telemarketing, via direct mail, via television or Internet advertising, or by any other means. Entities may also contact sales department 112 and/or marketing department 114 on their own initiative, thereby becoming leads. In one embodiment, some of the leads become sales opportunities (hereinafter referred to as “opportunities”).

At identification stage 204, certain leads are identified as opportunities and represent potential sales. In one embodiment, for a lead to become an opportunity, the entity contacted by the lead must express a willingness to conduct business with dealer 110, and must express a desire to purchase, in the near term, the type of products sold by dealer 110. As described further below, opportunities may be tracked (e.g., counted, monitored, recorded, etc.) as they pass through the different stages of the sales funnel, beginning with identification stage 204. In one embodiment, opportunities are tracked at each stage using one or more computer software applications, such as Microsoft Excel. In one embodiment, after a lead becomes an opportunity, it may move to qualification stage 206 if a member of dealer 110 (e.g., a marketing representative, sales representative, etc.) contacts the potential customer within a certain period of time (e.g., 24 hours, 48 hours, 5 days, etc.) to discuss a sale. If the potential customer is not contacted within a specified period of time, or if the potential customer expresses no further interest in a sale, then the opportunity moves to the closed no deal stage 216.

At qualification stage 206, dealer 110 and a potential customer discuss the potential sale. In one embodiment, during qualification stage 206, dealer 110 and the potential customer may discuss buyer requirements and identify a dealer solution. In addition, during qualification stage. 206, dealer 110 may identify the types of buyers of the potential customer to determine who best to discuss the sale with. In one embodiment, qualification stage 206 additionally includes identification of desired customer purchase terms (e.g., delivery terms, price ranges, product support expectations, etc.), and identification of dealer and customer risks and risk mitigation factors (e.g., safety risks, economic risks, etc.). In one embodiment, dealer 110 and the potential customer reach an agreement (e.g., oral and/or written) to pursue the identified solution, and the opportunity moves to development stage 208. However, if dealer 110 and the potential customer do not agree to pursue the sale, then the opportunity moves to the closed no deal stage 216.

At development stage 208, dealer 110 and the potential customer further discuss sales terms. In one embodiment, during development stage 208, the potential customer agrees to specific sales terms (e.g., product specifications, necessary support tools, delivery terms, target price, service plans, etc.). In addition the parties may identify and discuss any applicable non-standard contract terms (e.g., terms related to regulatory conditions of the sale, possible licensing provisions, etc.). In one embodiment, during development stage 208, dealer 110 ensures that an economic buyer associated with the potential customer understands the solution and its benefits. In another embodiment, during development stage 208, any existing competing dealers are identified and discussed, non-standard terms are resolved, and risks are reviewed and if possible are reduced. If, after the development stage 208 discussions are complete, the dealer 110 and potential customer are still interested in a sale/purchase, then the opportunity moves to proposal stage 210. However, if during or after the development stage 208 discussions, the dealer 110 and/or potential customer decide not to pursue the sale, then the opportunity moves to the closed no deal stage 216.

At proposal stage 210, all remaining issues are identified and discussed (e.g., financing terms, insurance policies, etc.), and all terms of the sale are discussed and resolved. In one embodiment, during proposal stage 210, a contract is prepared for the sale. The contract may include all terms of the sale, but may additionally provide certain terms which may be changed prior to a formal agreement (e.g., final price terms, final delivery date, etc.). If a contract is drafted and the parties agree to a final date for acceptance or rejection of the contract, the opportunity moves to the closed stage 212. However, if no contract is drafted and/or the parties agree to discontinue pursuing the sale, then the opportunity moves to the closed no deal stage 216.

At closed stage 212, a contract has been prepared, and the potential customer must decide whether to accept the contract or to reject the contract. If the potential customer accepts the contract, the opportunity becomes a sale, and is considered a closed won sale (212a). If the potential customer rejects the contract because it purchases the products from a competitor of dealer 110, then the opportunity becomes a lost sale, and is considered a closed lost sale (212b). If the potential customer rejects the contract for some other reason, the opportunity is moved to closed no deal stage 216. As further described below, the total amount of closed won sales, closed lost sales, and closed no deal opportunities are stored and may be used to calculate ratios or other values that reflect dealer 110's effectiveness and ability to achieve its business plan. In one embodiment, some of these ratios may be represented as follows:

$$Funnel Ratio = \frac{\begin{matrix}Closed Won Sales + Closed Lost Sales + \\ Closed No Deal\end{matrix}}{Closed Won Sales}$$

$$Close Rate = \frac{Closed Won Sales}{Closed Won Sales + Closed Lost Sales}$$

$$\begin{matrix}Participation \\ Rate\end{matrix} = \frac{Closed Won Sales + Closed Lost Sales}{Total Industry Sales}$$

$$PINS = \frac{Closed Won Sales}{Total Industry Sales}$$

The funnel ratio indicates the number of opportunities that the dealer (e.g., marketing and sales departments) must generate to make a successful sale (i.e. “closed won sale”). Thus, a lower ratio indicates that a higher percentage of opportunities result in closed won sales. A low funnel ratio may indicate a strong and effective sales force and/or a marketing department that provides higher quality leads. A higher funnel ratio may indicate a less effective sales force and/or a marketing department that provides lower quality leads. The close rate measures the number of closed won sales against the total number of closed won sales and closed lost sales. Thus, a higher close rate indicates a more effective sales force during the closed stage. A lower close rate indicates that a greater number of opportunities are being lost in the closed stage. Participation rate reflects dealer 110's participation in total sales (e.g., closed won and closed lost) compared to the total industry sales, while PINS (i.e. percentage of industry sales) reflects the percentage of closed won sales made by the dealer compared to the overall industry sales. PINS may also be determined by multiplying participation rate by close rate. These rates and ratios are further discussed below.

In one embodiment, both the sales department 112 and the marketing department 114 are involved in the sales funnel process. For example, leads may generate from both the sales department 112 and the marketing department 114. Both sales and/or marketing may qualify leads entering the funnel as opportunities. In one embodiment, throughout the business cycle, members of sales department 112 and marketing department 114 participate in meetings to discuss the progress of opportunities through the sales funnel.

For example, one type of meeting is a periodic (e.g., weekly, bi-weekly, monthly, etc.) meeting between the marketing manager and the sales manager. It is important that the marketing and sales managers maintain ongoing communication. Feedback from sales department 112 may help provide marketing department 114 with insight into which marketing campaigns generate the highest quality opportunities (e.g., the most likely to reach the closed stage and/or result in closed won sales). In one embodiment, during these meetings, the marketing and sales managers review the opportunities supplied from marketing department 114 to assure that the funnel is being supplied with an adequate number of opportunities to meet dealer 110's business plan. The parties additionally may review ratios (e.g., close rate, funnel ratio, participation rate, etc.), may review opportunities supplied by different sources (e.g., mail, e-mail, telemarketing, trade shows, etc.), and may determine where intervention is needed by sales department 112 based on this review. In one embodiment, a computer software application, such as Microsoft Excel™, is used to record and monitor the opportunities supplied from marketing department 114 and sales department 112. An exemplary software program is further described below.

Another type of meeting is a periodic (e.g., daily, weekly, monthly, etc.) meeting between the sales manager and the sales representatives. During these meetings, the sales manager and representatives discuss the progress of each sales representative's opportunities through the sales funnel. In a similar manner to the sales-marketing meetings, a sales manager may use a software program to analyze the progress of each opportunity and of groups of opportunities that sales-representatives procure throughout the sales funnel. For example, the sales manager may review the number of opportunities in each stage to ensure enough activity is in the funnel to attain a monthly target goal for each sales representative. In one embodiment, the sales manager uses a software program to determine the number of opportunities and to estimate a number of opportunities necessary to achieve the business plan for sales. The sales manager may also perform an in depth review of individual opportunities that are stagnant in the funnel. Based on this review, the sales manager may discover a particular problem to remedy. The sales manager may then share any discovered information with the entire sales department 112 to inform sales department 112 how to successfully close more opportunities.

A third type of meeting involves dealer 110 and manufacturer 130. On a periodic basis (e.g., weekly, monthly, bi-monthly, etc.), one or more members of dealer 110 and manufacturer 130 may meet to discuss dealer 110's business plan and whether it appears to be achievable. The same information reviewed in the sales-marketing, and/or sales manager-sales representative meetings can again be reviewed in these meetings.

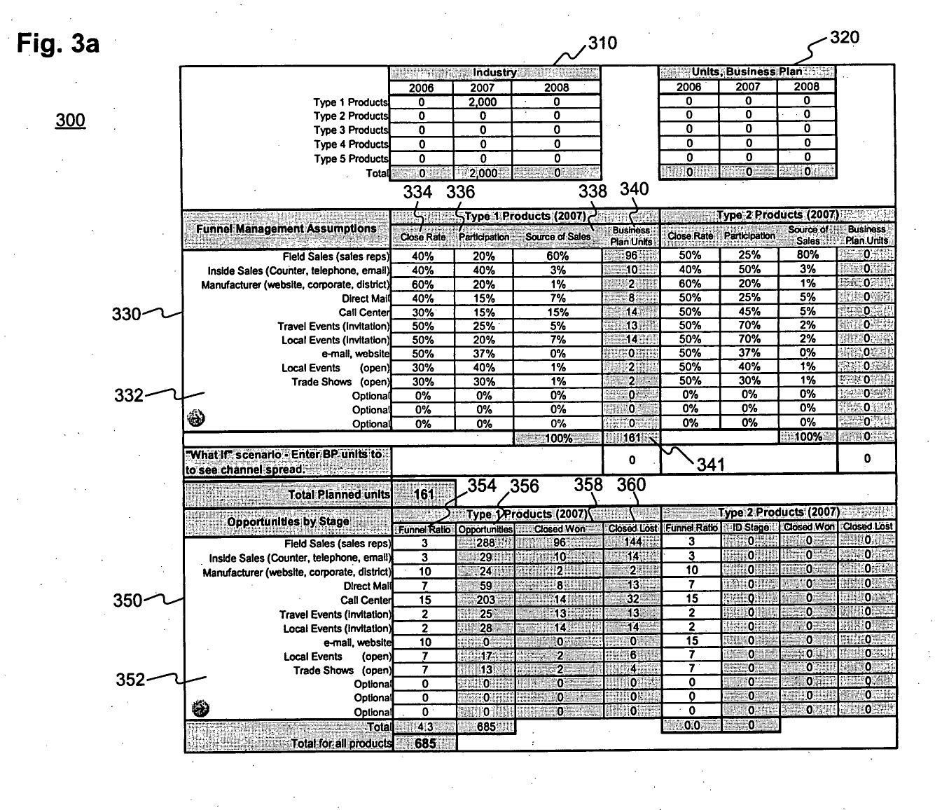

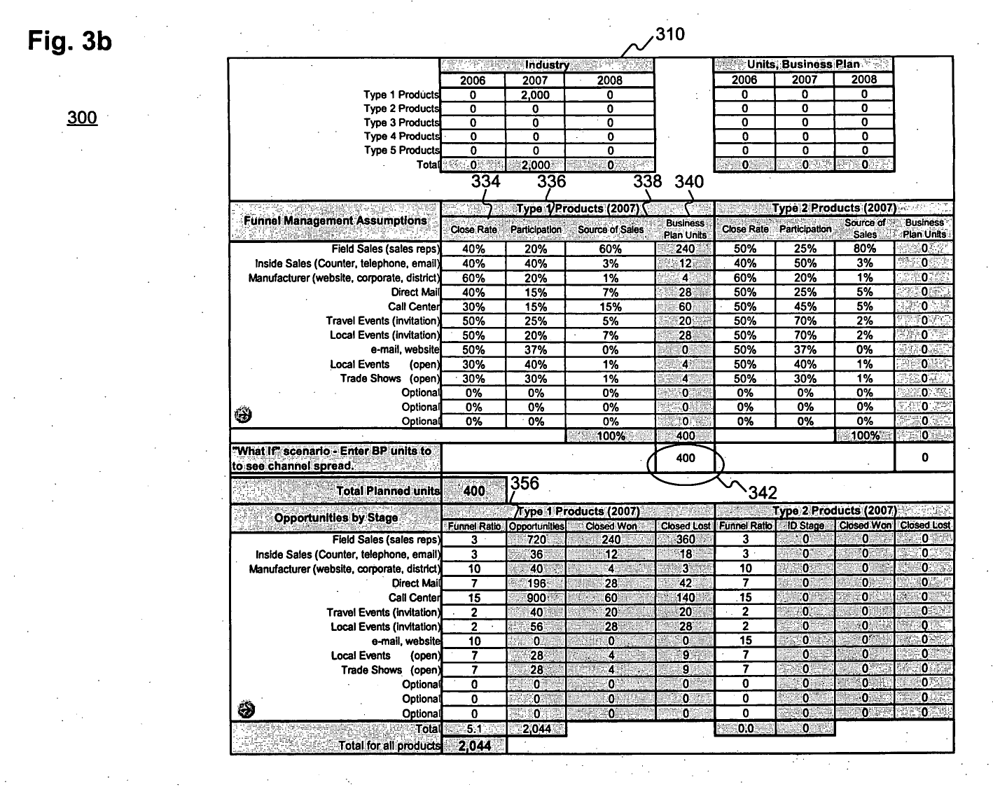

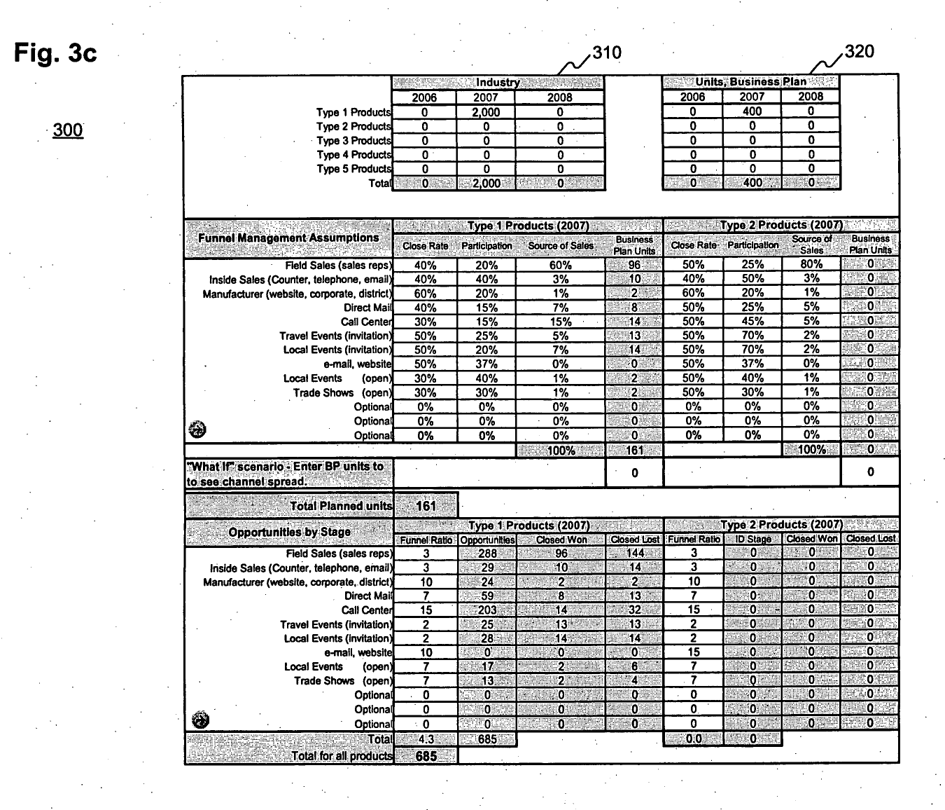

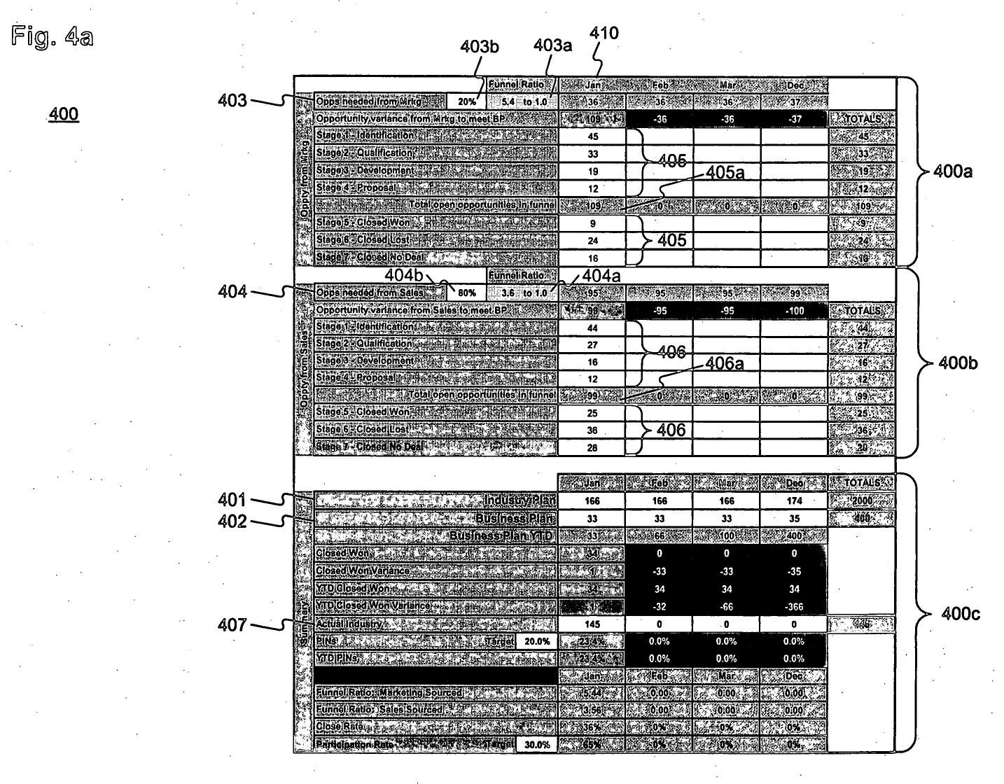

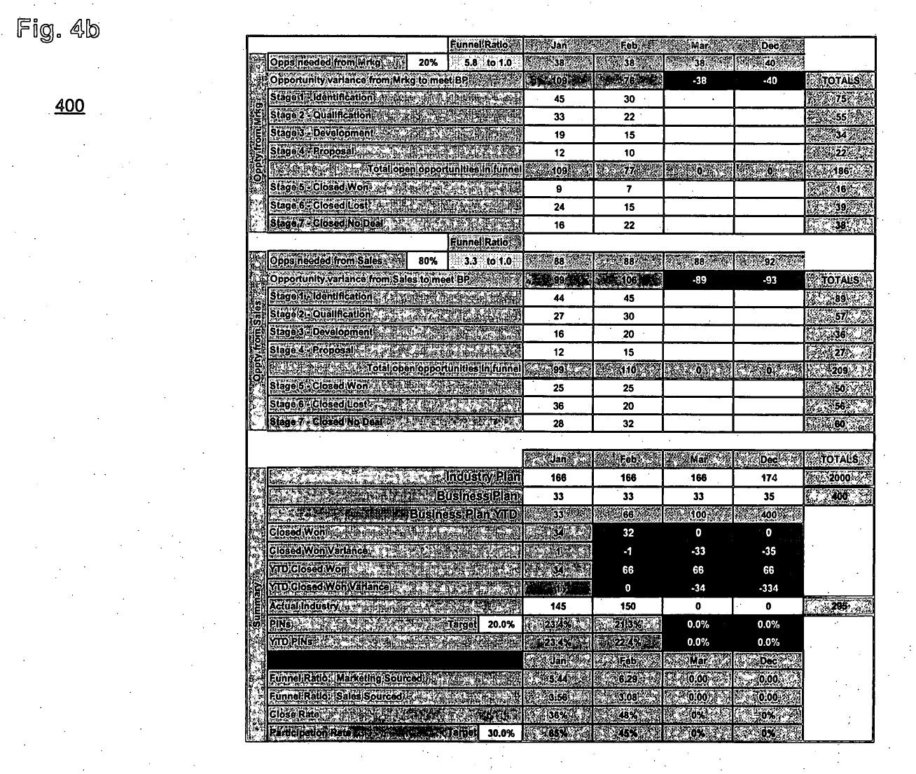

As described above, a computer software application may be used to analyze opportunity and sales information related to the sales funnel. For example, in one embodiment, the dealer may use Microsoft Excel to create a spreadsheet for use in analyzing both the dealer's business plan and the current state of opportunities passing through the sales funnel. In one embodiment, spreadsheets such as depicted in FIGS. 3a, 3b, 3c, 4a, and 4b may be used for this analysis.

FIGS. 3a, 3b, and 3c each depict an exemplary data file used to develop a business plan for sales of one or more products for an upcoming year. In one embodiment dealer 110 uses a data file, such as data file 300 depicted in FIGS. 3a, 3b, and 3c, to determine the number of expected sales and opportunities it must produce for an upcoming year. Although FIGS. 3a, 3b, and 3c depict certain data, additional data (not shown) may be stored and/or displayed in the data file, as described further below.

Data file 300 includes a number of portions that store data related to sales and opportunities for one or more products for one or more years. For example, as illustrated in FIG. 3a, in one embodiment, data file 300 includes expected industry sales portion 310, business plan sales portion 320, sales source management portion 330, and opportunity source management portion 350.

Expected industry sales portion 310 stores data reflecting annual expected industry sale amounts organized by product category. For example, in the embodiment depicted in data file 300, data may be entered, stored, and/or altered for each of years 2006, 2007, and 2008, for five different categories of products (e.g., Type 1, Type 2, Type 3, Type 4, and Type 5). In one embodiment, the different categories of products may reflect different sized equipment. For example, Type 1 products may correspond to engine-sized equipment, while Type 5 products may reflect dozer-sized equipment. However, any types of products and any categorization may be reflected in the rows of portion 310. In the embodiment depicted in FIG. 3a, portion 310 stores data reflecting 2000 expected industry sales of Type 1 products in the year 2007. In one embodiment, the “industry” depicted in portion 310 may include an industry that typically manufactures and sells certain lines of products (e.g., heavy machinery and machine parts).

The values shown in portion 310 are exemplary only, and will vary in an actual industry according to expected industry sales. In one embodiment, only data for one type of product is provided to portion 310, to enable a user to view predicted sales and opportunity amounts for only the single product type. However, information reflecting two of more of the product types and two or more years of data may be provided to portion 310. In one embodiment, the values entered into portion 310 are based on a prediction of upcoming industry sales. The prediction may be derived from past sales trends, current sales, or any other criteria, and may be derived using one or more computer programs, databases, or other business analysis tools.

Business plan sales portion 320 stores data reflecting a dealer's expected or planned annual sale amounts organized by product category and year. In the embodiment shown in FIG. 3a, no sales data has been provided to sales portion 320. An exemplary method of providing data to sales portion 320 will be described further below.

Sales source management portion 330 stores data reflecting different product ratios for each of a number sales sources, and expected dealer sales (i.e. closed won sales) for each of the sales sources. A sales source generates opportunities, some of which result in sales. Sales sources portion 332 may include data reflecting one or more opportunity-generating source for sales of the products. In one embodiment, sales sources portion 332 includes text reflecting sales sources, including: field sales from sales representatives (e.g., sales representatives visiting potential customers); inside sales generated from within the dealer (e.g., dealer counter, telephone calls, e-mails); sales resulting from manufacturer 130 (e.g., a manufacturer website, corporate deals, regional district solicitations); and sales resulting from direct mail, call centers, travel events, local events (open or by invitation), dealer e-mail and/or websites, and trade shows. In one embodiment, the “field sales” source corresponds to sales generated by a sales department, such as sales department 112, and the other sales sources depicted in FIG. 3a correspond to sales generated by a marketing department, such as marketing department 114. Other sales sources maybe included or added to sales source management portion 330.

Portion 330 additionally includes close rate column 334, participation rate column 336, source of sales rate column 338, and expected number of dealer sales units column 340. These columns, may be included in portions of data file 300 for one or more types of products, as shown in FIG. 3a (e.g., Type 1 products, Type 2 products, etc.). In the embodiment shown in FIG. 3a, close rate column 334 includes data reflecting the expected close rate for Type 1 products for 2007 for each of the sales sources listed in portion 332. Thus, in the embodiment shown in FIG. 3a, the close rate for field sales is 40%, inside sales is 40%, etc. As described above, close rate equals the ratio of closed won sales to closed won sales plus closed lost sales.

In the embodiment shown in FIG. 3a, participation rate column 336 includes data reflecting the expected participation rate for Type 1 products for 2007 for each of the sales sources listed in portion 332. As described above, participation rate equals the ratio of closed won sales plus closed lost sales to the total industry sales. Source of sales column 338 may include data reflecting the expected percentage of sales generated from each source compared to each other source. For example, a percentage of 60% for field sales represents an expectation that 60% of the overall dealer sales will come from opportunities generated from field sales representatives.

In one embodiment, based on the values in expected industry sales portion 310 and columns 334, 336, and 338, an expected number of dealer sales, as shown in column 340, is calculated for each sales source. A total number of expected dealer sales for the product and year (e.g., Type 1 product for 2007) is also provided in cell 341 (e.g., 161 units). In one embodiment, the number of expected dealer sales for each source is calculated by multiplying the product of close rate, participation rate, and source of sales rate by the number of industry sales for that source. Thus, a dealer determines an expected number of dealer sales based on the assumed industry sales and product ratios provided. This number (e.g., 161) provides an estimate of the percentage of industry sales that the dealer can expect of its products, based on current market assumptions. In the exemplary embodiment shown in FIG. 3a, the estimated percentage of industry sales would be 8% (e.g., 161 dealer sales divided by 2000 industry sales).

Opportunity source management portion 350 includes the same list of sales sources shown in portion 330 (i.e. sales sources portion 352), and includes additional information showing expected opportunities and sales at certain stages of the sales funnel. Funnel ratio column 354 is an estimated funnel ratio for the sales source (e.g., the number of total closed won sales, closed lost sales, and closed no deal opportunities generated by the sales source divided by the number of closed won sales derived from those opportunities). Certain sales sources may have higher ratios than others. For example, field sales sources will typically have a lower funnel ration than call centers, because field sales representatives often contact potential customers who are already in business with the dealer and are more likely to continue. Closed won column 358 includes the number of expected closed won dealer sales derived from each source. The values in column 358 correspond to the values in column 340 of portion 330. Note that the exemplary values in these columns shown in FIG. 3a are rounded-up estimates of product sales. However, the disclosed embodiments may comprise any type of values.

Opportunities column 356 includes, for each sales source, data reflecting the number of opportunities needed to generate the number of sales estimated in expected number of dealer sales column 340. The values in column 356 are calculated by multiplying the closed won expected sales values from column 358 by the funnel ratio values in column 354 for each sales source. Because the values displayed in column 358 are rounded values while the actual values may include decimal values, the actual number of opportunities stored in exemplary column 356 of FIG. 3a varies slightly from the displayed values.

Closed lost column 360 includes values reflecting expected closed lost sales based on the provided industry sales value in portion 310, the provided funnel ratio in column 354, and the assumptions values in portion 330. The closed lost values are calculated by dividing the closed won value from column 358 by the close rate in column 334 for each sales source, and subtracting the closed won value in column 358 from the result. As such, in the embodiment shown in FIG. 3a, the closed lost value for field sales is 144, the closed lost value for inside sales is 14, etc.

Although FIG. 3a depicts data file 300 including certain information, data file 300 may include additional information or less information. For example, in one embodiment, data file 300 includes portions for all five of the product types listed in portions 310 and 320. In another embodiment, additional types of products may be listed in portions 310 and 320 and 330 as well. Furthermore, in one embodiment, an additional table is provided that includes the number of contact attempts necessary for each sales source to produce the expected number of opportunities calculated in column 356. The number of contact attempts value may be calculated by dividing the number of opportunities calculated in column 356 by one or more additional ratios (e.g., an opportunity generation ratio reflecting the number of opportunities generated per attempt, a contact rate reflecting the number of contacts necessary to generate one opportunity, etc.). In one embodiment, data file 300 includes cost data reflecting the cost to each sales source for carrying out its marketing campaign.

In one embodiment, cells shown without shading in FIG. 3a include values entered by a user or by a computer program (e.g., pivot table information uploaded to data file 300 from a computer program, such as Seibel™), while shaded cells include formulas for calculating values. However, such a layout is merely one example and other formats, computer algorithms, and software may be implemented.

In one embodiment, once the values shown in FIG. 3a are calculated based on the provided industry sales value (e.g., 2000) and the provided ratios (e.g., those shown in columns 334, 336, 338, and 354), a user (e.g., sales manager, sales representative, marketing manager, marketing representative,.etc.) may view data file 300 to determine whether the predicted sales values are sufficient to meet the dealer's business plan. For example, in one embodiment, the business plan may require that the dealer achieve a certain percentage of industry sales (“PINS”). Thus, based on the provided industry sales (e.g., 2000) and the calculated dealer sales (e.g., 161), a user can determine whether that percentage will be achieved. If so, then the dealer knows the number of opportunities necessary to achieve the business plan (e.g., the values in column 356). However, if based on the provided values, the dealer determines that additional opportunities must be generated to achieve the business plan, then additional information may be provided to data file 300.

For example, in one embodiment, to estimate a number of opportunities necessary to achieve a business plan, the dealer may provide values that directly estimate a number of sales into cell 342, as shown in FIG. 3b. In the embodiment shown in FIG. 3b, the value provided in cell 342 (e.g., 400) corresponds to a desired number of closed won sales for Type 1 products in 2007 for the dealer. This value may reflect a target number of sales necessary to achieve the dealer's business plan based on the expected industry sales provided to industry sales portion 310 (e.g., 2000 industry sales). For example, in one embodiment, the dealer may strive to achieve 20% of industry sales, and thus would enter the value of 400 dealer sales into cell 342. As shown in FIG. 3b, when a value is entered into cell 342, the values displayed in column 340 change. In one embodiment, the cells in column 340 include formulas that instruct the cells to calculate and display values based on the value provided to cell 342, whenever a non-zero value is entered into cell 342. For example, if the value of cell 342 is zero, then the values displayed in column 340 will reflect expected sales based on the number of industry sales provided to portion 310 and the ratio values provided to columns 334, 336, and 338. However, if a non-zero value is provided to cell 342 (e.g., 400), then the values displayed in column 340 will reflect expected sales based on the number of dealer sales provided to cell 342 and the source of sale percentages in column 338 (e.g., by multiplying the total number of dealer sales, 400, by the source of sales percentage for each source).

By allowing the dealer to enter dealer sales values directly into cell 342, the dealer can quickly determine the number of sales that each sales source must generate, as well as the number of opportunities that each sales source must generate to produce those sales. The dealer can also quickly compare expected dealer sales based on expected industry sales versus desired dealer sales to achieve a desired business plan. The number of opportunities shown in column 356 (e.g., 720 for field sales, 36 for inside sales, etc.) reflects the number of opportunities that each sales source must generate for the dealer to achieve its business plan goals. Thus, in the example shown in FIG. 3b, the dealer may determine that to achieve 20% of expected industry sales, field sales representatives will need to generate 720 opportunities, inside sales sources will need to generate 36 opportunities, etc. The dealer can then use these values to plan its next year's business. For example, in one embodiment, the dealer may develop a business plan by planning advertising campaigns (e.g., allocating funds and resources for advertising), hiring new employees, order supplies, setting employee sales quotas, opportunity quotas, and bonus incentives, etc. The dealer may then implement a business strategy by following the business plan.

In one embodiment, the dealer can compare the sales and opportunities values in columns 340 and 356 generated from only industry sales to the same values generated based on dealer sales values inputted directly into cell 342 to determine the most feasible business plan. Once a business plan is determined, the dealer may set cell 342 back to zero, and may enter the desired business plan sales value (e.g., 400) into sales portion 320, as shown in FIG. 3c. Based on the data input into portions 310 and 320, the dealer may calculate and track monthly sales using the data file 400 depicted in FIGS. 4a and 4b.

FIG. 4a shows a data file 400 used to track live, monthly opportunities and sales as they pass through the sales funnel. Data file 400 includes information imported from data file 300 that reflects the business plan and also includes current monthly actual sales and opportunity data. Data file 400 may be used to compare actual monthly sales and opportunities to the annual and/or monthly business plan to determine whether a dealer is on target to achieve its business goals. In one embodiment, data file 300 and data file 400 are part of a common spreadsheet file, such as a Microsoft Excel spreadsheet. For example, data file 300 may be accessible via a first tab on a spreadsheet and data file 400 may be accessible via a second tab. In another embodiment, the two data files may be on separate spreadsheet files.

In one embodiment, data file 400 includes marketing opportunity section 400a, sales opportunity section 400b, and summary section 400c. Marketing opportunity section 400a includes data reflecting opportunities generated from marketing as they pass through the sales funnel. Sales opportunity section 400b includes data reflecting opportunities generated from sales as they pass through sales funnel. Summary section 400c includes data reflecting overall sales and ratios. The data maintained in data file 400 may reflect sales and opportunity values for a single product or type of product, or may reflect sales and opportunity values for multiple types of products. In the embodiment depicted in FIG. 4a, the data reflects sales and opportunities for Type 1 products, based on the Type 1 product data provided to portions 310 and 320 of data file 300 in FIG. 3c.

Some of the values provided to data file 400 are derived from values input into data file 300. For example, the values in row 401 correspond to a monthly breakdown of the annual industry sales values entered into portion 310 of data file 300. In one embodiment, for example, the values “166” for each month add up to the total of 2000 Type 1 products provided in portion 310 of data file 300. The values in row 402 correspond to a monthly breakdown of dealer business plan sales entered into portion 320 of data file 300. In one embodiment, for example, the values “33” for each month add up to the total of 400 Type 1 product dealer sales provided in portion 320 of data file 300. The values in rows 401 and 402 may be derived by dividing the annual values provided in portions 310 and 320 of data file 300 by 12 (e.g., average monthly values), or may be derived other methods (e.g., by assigning different sales amounts to different months based on expected monthly fluctuations in sales).

Rows 403 and 404 include data reflecting the number of expected opportunities necessary to achieve the monthly business plan sales. Based on the business plan values in row 402, the funnel ratios in cells 403a and 404a, and the percentages in cells 403b and 404b, a monthly expected value is calculated for monthly opportunities necessary to maintain the business plan. This value is shown as “36” in row 403, and “95” in row 404 (except for December, which includes “37” in row 403 and “99” in row 404).

In one embodiment, actual monthly opportunity and sales values may be provided to the cells in column 410. For example, data reflecting a number of opportunities in each stage of the sales funnel may be entered into cells 405 for opportunities generated from marketing and cells 406 for opportunities generated from sales. Total open opportunities in the funnel may also be displayed, as shown in cells 405a and 406a. These totals may be compared to the monthly expected opportunity values displayed in rows 403 and 404 to determine whether the dealer is supplying enough opportunities to achieve the monthly business plan. The values entered into these cells may be entered on a monthly basis, or may be entered and updated on a weekly basis, daily basis, or based on any other period of time.

Portion 400c of data file 400 includes various calculated values, and also includes row 407 that permits a user to enter actual industry sales for each month. Thus, in one embodiment, portion 400c includes data reflecting closed won sales for the month (e.g., 34 for January), actual industry sales for the month (e.g., 145), percentage of industry sales for the month (e.g., 23.4%), monthly funnel ratios for marketing sourced sales (e.g., 5.44) and sales sourced sales (e.g., 3.56), close rate (e.g., 36%), and participation rate (e.g., 65%). The dealer can view these values and compare them to the expected rates (e.g., 20% percentage of industry sales, and 30% participation rate) to determine whether the actual business sales are consistent with the predicted business plan. In some cases, if the actual values differ substantially from the predicted values provided to data file 300, the dealer may update the data file 300 values to better conform to the actual values. In this way, data file 300 and data file 400 may be used together to better estimate and track a dealer's business plan throughout the annual business cycle.

In one embodiment, based on the comparison between actual opportunities and expected opportunities, the sales manager and/or marketing manager may determine problem areas within the sales funnel that need improvement. For example, if the close rate is too low, the sales manager may approach sales representatives to discuss how to improve closed won sales. In addition, based on the information in data file 300 and/or data file 400, the sales manager and/or marketing manager may review data related to individual sales or individual sales representatives to determine, for example, if a particular sale representative is not producing enough sales. Based on this information, the manager may intervene to improve sales and opportunities moving throughout the sales funnel.

FIG. 4b depicts data file 400 after being populated with exemplary data for a second month (e.g., February). Although certain months are hidden in FIGS. 4a and 4b, in one embodiment, all-twelve months of the year as well as annual totals may be displayed in data file 400. Furthermore, the data entered into data file 400 for each month may be input manually or automatically. In one embodiment, the data is automatically provided to data file 400 from one or more pivot tables that store information about each individual sale. Data files 300 and 400 may be stored in a computer system having known components (e.g., CPU, memory, data busses, input/output devices, a display screen, etc.). The computer system may be a PC, laptop, hand-held device, a network of computers, or any other known device capable of implementing the embodiments disclosed herein.

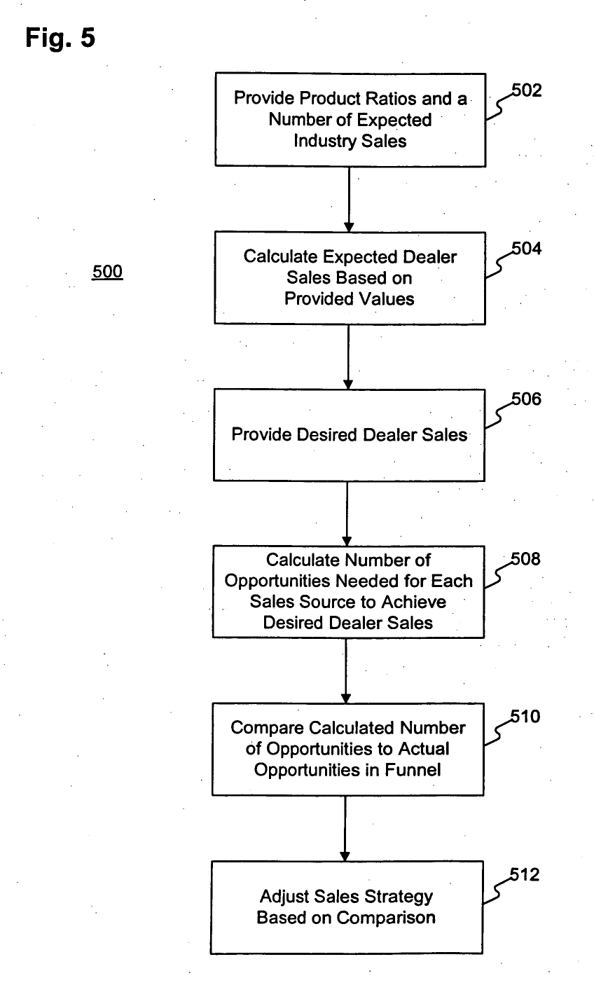

FIG. 5 is a block diagram of a method 500 consistent with certain disclosed embodiments. In step 502, expected industry sales data and ratio data related to a product are provided to a data file, such as data file 300. In one embodiment, the sales data may include values provided to data file 300 (e.g., entered by a user, automatically input by a computer program, etc.) relating to sales of one or more types of products for one or more years. The ratio data may include close rates, participation rates, and source of sales rates for each of a number of sales sources. A funnel ratio for each of the different sales sources may be provided as well.

In step 504, based on the values provided in step 502, expected dealer sales values for each sales source are calculated. These values may reflect an expected number of dealer sales generated from each sales source, based on an expected industry sale amount for a product or product type and one or more of the product ratios. Based on these values, the dealer may determine whether a business plan is likely to be achieved. If the business plan is unlikely to be achieved based on the values provided in step 502, then a desired number of dealer sales may be entered into the data file (step 506). In one embodiment, this number depends on a planned percent of industry sales desired by the dealer. This number may be entered into the data file without deleting the stored expected industry sales data. For example, in one embodiment, the desired number of dealer sales may be entered into cell 342 and/or portion 320 of data file 300, without deleting the stored expected industry sales data in portion 310.

Based on the number of dealer sales entered into the data file, a number of opportunities needed to achieve the sales may be calculated in step 508. In one embodiment, a number of opportunities is calculated for each sales source. In one embodiment, these opportunities represent a number of opportunities necessary to achieve the dealer's business plan for sales of the product or type of product.

In step 510, the actual number of sales and opportunities is provided to a data file, such as data file 400. In one embodiment, the actual number of sales and opportunities is provided for each month to a data file, and may be entered and/or added to the data file on a periodic basis (e.g., daily, weekly, monthly, etc.). The provided information may include the number of opportunities passing through each stage of the sales funnel (e.g., identification stage, qualification stage, development stage, proposal stage, closed won stage, closed lost stage, and closed no deal stage). Additional information may be provided to the data file as well. In one embodiment, the additional data includes an actual amount of industry sales for each month.

Based on the actual sales and opportunity data provided to the data file, a comparison may be made between expected sales and opportunities and actual sales and opportunities to determine whether the dealer is on track to achieve the business plan. In one embodiment, for each month, an actual percent of industry sales ratio may be compared to a predicted percent of industry sales ratio. In another embodiment, actual closed won values may be compared to predicted closed won values. In yet another embodiment, total opportunities in the sales funnel may be compared to total predicted opportunities in the sales funnel. In one embodiment, the comparisons may compare data combined over a single month, a number of months, or any other time period.

In step 512, depending on the data comparison, a manager or other member of the dealer may intervene with the dealer's sales in order to fix any problem areas, as discussed previously in connection with FIGS. 1 and 2. For example, in one embodiment, a sales manager may meet with sales representatives or a marketing manager to discuss sales or marketing campaigns that are not achieving their expectations. These meetings may result in an improved sales and/or marketing strategy to increase sales, opportunities, efficiency, or other business criteria.

### INDUSTRIAL APPLICABILITY

The sales funnel management method and system described above can be used to manage sales for any product or set of products sold by a dealer. For example, in one embodiment, the system and method may be used to create a business model for sales of machines and machine equipment, and to track monthly sales of the machines and machine equipment to ensure that the monthly sales amounts fall within the estimated business plan amounts. For example, in one embodiment, sales and opportunity information is collected and predicted for different categories of machines and machine equipment. In one embodiment, the categories may be organized according to machine size or horsepower. Based on the information for the different categories of machines, the dealer may assess the business plan for any one of the categories, or any group of the categories.

In addition, although certain sales sources are described herein, any sales source may provide opportunities for sales of products, and may thus be included in a data file for use with the disclosed embodiments. Also, although the sales funnel management method and system is described for use by a dealer, it may be used by any business entity that markets and sells products and/or services (e.g., any company, corporation, government agency, non-profit organization, etc.). Furthermore, although data sets are grouped by year and month in the disclosed embodiments, such grouping is not meant to be limiting. Any periods of time can be used to perform the disclosed embodiments.

It will be apparent to those skilled in the art that various modifications and variations can be made to the sales funnel management embodiments disclosed herein. Other embodiments will be apparent to those skilled in the art from consideration of the specification and practice of the disclosed sales funnel management system and method. It is intended that the specification and examples be considered as exemplary only, with a true scope being indicated by the following claims and their equivalents.

Further, although the disclosed embodiments include exemplary spreadsheets, it should be noted that any type of file and corresponding data structure may be used to store, process, and display the sales funnel management information used in the disclosed embodiments. Further, one or more processors that executes program code may be implemented to perform one or more of the sales funnel management processes disclosed herein. For example, one or more processors in a computer system may execute software that performs one or more of the functions programmed in given cells of the disclosed sales funnel management data file described herein. The software may be stored in a computer readable medium (e.g., hard disk, CD-ROM, flash memory, or any other medium capable of storing executable computer code). Also, the configuration of the spreadsheet shown is not limited to that shown or described in FIGS. 3a, 3b, 3c, 4a, and 4b. Additionally, a network of computers may communicate and collaborate to perform one or more processes consistent with the disclosed embodiments.

What is claimed is:

1. A method for developing a business plan for a business entity, comprising:
providing a value indicating a predicted amount of business entity sales for one or more products;
based on the provided value, determining, for each of one or more sales sources, an expected amount of opportunities necessary to generate the predicted amount of business entity sales;
storing a respective indicator of the predicted amount of opportunities for each of the one or more sales sources; and
using the one or more respective indicators to develop a business plan.

2. The method of claim 1, further including:
automatically determining the expected amount of opportunities, for each of the one or more sales sources, based at least on the predicted amount of business entity sales.

3. The method of claim 1, further including:
determining the expected amount of opportunities for each of the one or more sales sources based on the provided predicted amount of business entity sales, a source of sales ratio provided for each of the one or more sales sources, and a funnel ratio provided for each of the one or more sales sources.

4. The method of claim 1, further including:
based on the provided predicted amount of business entity sales, comparing whether an amount of actual business entity sales for a particular time period is above, below, or equal to the predicted amount of business entity sales for the time period.

5. The method of claim 4, further including:
providing the results of the comparison to a sales manager and at least one of a sales representative and a marketing manager.

6. The method of claim 1, further including:
including in the one or more sales sources, at least one source from a sales department and at least one source from a marketing department.

7. The method of claim 1, further including:
providing at least one expected industry sales value, the at least one expected industry sales value indicating an expected amount of sales for one or more products in an industry; and
for each of a one or more sales sources, storing an indicator of an amount of opportunities that must be generated by the respective sales source, to result in the expected number of sales.

8. The method of claim 7, further including:
calculating the expected amount of opportunities, for each sales source, based on the at least one expected industry sales value, a close rate for the sales source, a participation rate for the sales source, a source of sales ratio for the sales source, and a funnel ratio for the sales source.

9. A method for determining an amount of opportunities for a business entity to generate, comprising:
providing at least one expected industry sales value to a data file, the at least one expected industry sales value indicating an expected amount of sales over a period of time for one or more products;
calculating an estimated amount of opportunities that must be generated by each of a plurality of sales sources to result in the expected amount of sales,.thereby calculating a first set of opportunity values;
displaying the first set of opportunity values;
providing at least one desired business entity sales value to the data file, the at least one desired business entity sales value indicating a desired amount of Sales to make over a period of time for the one or more products by the business entity; and
calculating a second set of opportunity values reflecting opportunities that must be generated by each of the plurality of sales sources to result in the desired amount of sales;
displaying the second set of opportunity values; and
using the second set of opportunity values to develop a business plan for the business entity.

10. The method of claim 9, wherein:
providing the at least one expected industry sales value includes providing at least one expected industry sales value indicating a desired sales amount over a one year period; and
providing the at least one desired business entity sales value includes providing at least one desired business entity sales value indicating a desired sales amount over a one year period.

11. The method of claim 9, further including:
comparing an amount of actual monthly business entity sales of the one or more products to an amount of desired monthly business entity sales of the one or more products based at least in part on the desired business entity sales value.

12. The method of claim 11, further including:
determining a value indicating a percentage of industry sales for the one or more products based on the amount of actual monthly business entity sales of the one or more products and an amount of actual monthly industry sales for the one or more products.

13. The method of claim 11, further including:
providing the results of the comparison to a sales manager and at least one of a sales representative and a marketing manager.

14. The method of claim 9, further including:
automatically calculating the first set of opportunity values and the second set of opportunity values.

15. The method of claim 9, further including:
calculating the first set of opportunity values based on the provided at least one expected industry sales value, a plurality of respective source of sales ratios provided for each of the plurality of sales sources, a plurality of respective participation rates provided for each of the plurality of sales sources, a plurality of respective close rates provided for each of the plurality of sales sources, and a plurality of respective funnel ratios provided for each of the plurality of sales sources.

16. The method of claim 9, further including:
calculating the second set of opportunity values, for each of the sales sources, based on the provided at least one desired business entity sales value, a plurality of respective source of sales ratios provided for each of the plurality of sales sources, and a plurality of respective funnel ratios provided for each of the plurality of the sales sources.

17. The method of claim 9, wherein the data file is stored in a computer system.

18. A computer program product stored on a computer-readable medium, the computer program product comprising:
instructions that, when executed, instruct one or more processors to store a value indicating a predicted amount of business entity sales for one or more products;
instructions that, when executed, determine, for each of one or more sales sources, an expected amount of opportunities necessary to generate the predicted amount of business entity sales, based on the stored value;
instructions that, when executed, instruct the one or more processors to store an indicator of the predicted amount of opportunities for each of the one or more sales sources; and
instructions that, when executed, instruct the one or more processors to display the stored one or more indicators.

19. The computer program product of claim 18, further including:
instructions that, when executed, instruct the one or more processors to automatically determine the predicted amount of opportunities for each of the one or more sales sources.

20. The computer program product of claim 18, further including:
instructions that, when executed, instruct the one or more processors to determine the predicted amount of opportunities for each of the one or more sales sources based at least on the stored value, a source of sales ratio provided for each of the one or more sales sources, and a funnel ratio provided for each of the one or more sales sources.
